(19) United States
(12) Patent Application Publication
(10) Pub. No.: US 2008/0134037 A1
(43) Pub. Date: Jun. 5, 2008

(54) RECORDING AND REPRODUCING DEVICE

(76) Inventors: Masahiro Fujimoto, Yokohama (JP); Yuichi Katano, Yokohama (JP); Keiji Nagayama, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/867,073

(22) Filed: Oct. 4, 2007

(30) Foreign Application Priority Data
Dec. 1, 2006 (JP) 2006-325136

(51) Int. Cl. G06F 3/048

(52) U.S. Cl. 715/716

(57) ABSTRACT

When any undubbed data out of the recorded data in a hard disk device, is dubbed to a DVD, it sometimes occurs that dubbing-completed data and undubbed data are mixed together in the hard disk. For this reason, it is not easy to select only the undubbed data before start of dubbing processing. In a recording and reproducing device including a dubbing function, dubbing of recorded data is made from the first recording media (e.g., a hard disk) to the second recording media (e.g., a DVD), and at that time, only the recorded data of an undubbed item selected from the menu, etc., is displayed before start of dubbing. Also, if the above recorded data of the dubbing source cannot be contained in a single DVD, then which recorded data is to be dubbed to second, third, or what other number of media, according to the recording media used by the dubbing destination, is displayed before dubbing processing.

### PRIORITY CLAIM/INCORPORATION BY REFERENCE

The present application claims priority from Japanese application P2006-325136 filed Dec. 1, 2006, the entire contents of the above application(s) hereby being incorporated by reference into this application.

### TECHNICAL FIELD

This invention relates to a recording and reproducing device.

### BACKGROUND ART

As a background art in the present technical field, there is, for example, Japanese Unexamined Patent Application Publication No. 2006-80890 (Patent Document 1). In this Publication, the problem to be solved by the invention is described as “it is necessary that desired image and sound data can be dubbed on a disk without additional fuss in searching for the data, even when image and sound data recorded in HDD increases in number,” and the means for solving the problem is described as “In a configuration comprising: the dubbing control means 12 to dub the image and sound data recorded in the device-side recording media 3 in the retrievable recording media 17 via the recording media driving section 2, and the search and display means 11 to search for the image and sound data conforming to the inputted search conditions by referring to the referential data affixed to the image and sound data, the search and display means 11, upon receiving input of search conditions, conducts search for the image and sound data conforming to the inputted search conditions to set it as the object for dubbing, and the dubbing control means 12 conducts dubbing of the image and sound data specified by the search and display means 11 as the object for search, into the retrievable recording media 17.” (Refer to Abstract.)

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. In the drawings, same or corresponding portions may be referenced by the same or similar reference numerals in order to eliminate redundant explanation.

The following represents brief descriptions of the drawings, wherein:

FIG. 1 is an example of composition of system components of an example video camera.

FIG. 2 shows an example flow of processing in an example video camera when dubbing of all undubbed scenes is carried out.

FIG. 3 shows an example of a disk navigation screen display.

FIG. 4 shows an example of a screen display in which a search is in progress for undubbed scenes.

FIG. 5 shows an example of a screen display for dubbing of all undubbed scenes only.

FIG. 6 shows an example of a dubbing start confirming screen display.

FIG. 7 shows an example of a dubbing-in-operation screen display for dubbing of undubbed scenes.

FIG. 8 shows an example of a dubbing-completed screen display for undubbed scenes.

FIG. 9 shows an example of a dubbing-processing completion screen display for undubbed scenes.

FIG. 10 shows an example of a continued dubbing confirming screen display for undubbed scenes.

FIG. 11 shows an example of a disk exchange requesting screen display.

FIG. 12 shows an example of a dubbing failure screen display for undubbed scenes.

FIG. 13 shows an example of a dubbing-completed scene deletion confirming screen display for undubbed scenes.

FIG. 14 shows an example of an undubbed-scene dubbing selection screen display for undubbed scenes.

FIG. 15 shows an external view of an example video camera.

FIG. 16 is an example conceptual diagram of recorded data stored in HDD and DVD.

FIG. 17 is an example conceptual diagram of a dubbing-completed data control area.

### DETAILED DESCRIPTION

Before beginning a detailed description of the subject invention, mention of the following is in order. In the detailed description to follow, example screen displays, sizes and capacities may be given, although the present invention is not limited to the same. Well known power/ground connections to ICs and other components may not be shown within the FIGS. for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. In other instances, detailed descriptions of well-known methods and components are omitted so as not to obscure the description of the invention with unnecessary/excessive detail. Multiple line (e.g., parallel) connections (including support components/circuitry) may be shown as a single line for simplicity of illustration and discussion, and so as not to obscure the invention. Arrowed or other interconnections shown between components may allow flow of information, etc. in a bidirectional manner. Where specific details (e.g., circuits, flowcharts) are set forth in order to describe example embodiments of the invention, it should be apparent to one skilled in the art that the invention can be practiced without, or with variation of, these specific details. Finally, it should be apparent that differing combinations of hard-wired circuitry and software instructions can be used to implement embodiments of the present invention, i.e., the present invention is not limited to any specific combination of hardware and software.

Although example embodiments of the present invention will be described using an example video camera environment, practice of the invention is not limited thereto, i.e., the invention may be able to be practiced with other types of electronic devices (e.g., cell phones, set-top boxes) in other types of environments.

Turning now to detailed description, in recent years, recording media such as hard disks and DVDs have become popular, paving the way for dubbing dynamic picture images and still picture images recorded in recording media in other recording media. For example, the hard disk has a large recording capacity, but because it is not a removable type of recording media, it lacks in general versatility in respect to a reproducing environment. As to a DVD, which is a removable type of recording media though its capacity is not large, it has a general versatility in respect to a reproducing environment. For this reason, reproduction may be practiced by using a HDD/DVD recorder to do dubbing of the recorded data of TV programs into a DVD for the convenience of reproduction in another reproducing environment. Similarly, the data recorded by a video camera may be dubbed in other recording media. DVDs which are originally regarded suitable for keeping of a library, can exert merits in terms of conservation environment as well as reproducing environment.

In carrying out dubbing, one may want to dub a single item of recorded data or plural items of recorded data. Sometimes one may want to dub the entire data recorded in a recording media. At this point, users normally check a list of recorded data in a navigation screen, and select the recorded data desired for dubbing which is to follow.

However, it is quite a difficult task and consumes much time and labor to choose desired items of recorded data out of plural items of data. In recent years, there has been much progress in development of large-capacity storage, and the amount of data recordable in one recording media is more on the increase than ever. In such circumstances, it is becoming important to get have a method of easily choosing recorded data desired for dubbing by way of retrieving title, date, recording initiation time, data amount, group, etc., of the recorded data.

Another problem that occurs when any recorded data recorded in a recording media is dubbed in another recording media, is attention must be directed to a recordable capacity of the destination recording media. In case plural items of recorded data in the dubbing source are chosen for dubbing, it is possible that the total volume of the recorded data of the dubbing source may exceed the capacity of the recording media as the dubbing destination. In such a case, selection needs to be reconsidered. To serve the purpose, the aforesaid patent document 1, for example, describes some of related art disclosing such methods that over-volume be indicated in the navigation screen prompting the user to review the choice of recorded data, or that the recorded data be recompressed so as to reduce the dubbing volume.

As to the method of dubbing as mentioned above for the recorded data, it can be a copy mode meaning that the recorded data is kept stored in the recording media of the dubbing source, or a transfer mode meaning that the data that was recorded in the recording media of the dubbing source is deleted. When dubbing is made in the copy mode, the recording media of the dubbing source will have both the recorded data after dubbing and the recorded data before or without dubbing in a mixed state (i.e., the source will contain already-dubbed data, and undubbed data). In such a mixed state of the data, the user may get mixed up in judging which recorded data have been dubbed into the other recording media when the user tries to confirm the status quo of the recorded data from the list on the navigation display.

Therefore, the related art described in the patent document 1 suggests that whether dubbing has been done or not yet be marked in the display, thereby enabling the user to judge whether dubbing is already done or not. However, even for this judgment from the markings in the display as to whether dubbing has been done or not, it takes much time and labor inasmuch as the capacity of a recording media has increased so as to be able to store more volume of recorded data in recent years.

Further, in case plural items of recorded data are selected for dubbing, the recording media of the dubbing destination may happen to be short of capacity. If such is the case, overflow recorded data needs to be dubbed in another recording media. For example, if the recording media of the dubbing destination is a DVD whose capacity is not large enough to take the volume of selected recorded data of the dubbing source, it will be necessary to use 2nd, 3rd, and any other number of new DVDs. The related art described in the patent document 1 explains about indication of over-capacity for the first piece of DVD, but makes no mention on over-capacity indication for the 2nd, 3rd, and any further additions of DVDs.

One object of the present invention is to enhance usability of a recording and reproducing device. For example, an object is to provide a recording and reproducing device that solves the abovementioned problems and permits the user to do dubbing more conveniently than ever.

To solve the abovementioned problems, one aspect of the present invention relating to the case in which dubbing is made from the first recording media (e.g., a hard disk) to the second recording media (e.g., a DVD), in brief, is that only those recording data of which dubbing has not been done yet are shown on a display, and selection is made from such display before the dubbing procedure.

Also, another aspect of the present invention, in brief, is that if the recorded data of the selected dubbing source is too large to be contained in a single DVD, the information as to which recorded data are to be dubbed continuedly in a second, third, and other number of DVDs is to be indicated before the dubbing procedure.

As described above, the present invention is directed to contribute to enhancement of usability of a recording and reproducing device. For example, the present invention applied to a recording and reproducing device including a dubbing function will enable the user to conduct dubbing work with much ease as possible to quickly select the recorded data of which dubbing has not been done yet, and to recognize which recording data is to be dubbed in second and subsequent recording media.

Any other problems, means, and effects are going to be explained afterward by way of embodiments.

Continuing now, as an image recording device, a digital video camera (hereinafter referred to as a “video camera”) in which a hard disk drive (hereinafter referred to as “HDD”) and a DVD (digital versatile disc) are built-in, is taken up for example explanation.

Incidentally, the present invention is found particularly meritorious for video cameras because the video cameras are in the focus of such demands as: firstly, the duration time of each scene is rather brief than a broadcasting program because shooting and stopping are repeated minutely in short cycles; secondly, storage is often made in order of shooting unlike broadcasting programs (which are more often than not stored in groupings of same or similar dramas); thirdly, easy-to-use feature is wanted as parents use the camera quite often to take pictures of their kids; and fourthly, easy reproduction on a player after shooting is also desired. The present invention is, of course, also effective for stationary type HDD/DVD recorders and other devices.

The devices to which the present invention is applied are not limited to DVDs but can be BDs (Blu-ray Discs) or HDs (High-Definition DVDs) or other optical disks. The device combinations are not limited to the combination of HDDs and optical disks, but may as well be other combinations of HDDs and semiconductor memory, or optical disks and semiconductor memory.

### EXAMPLE EMBODIMENT 1

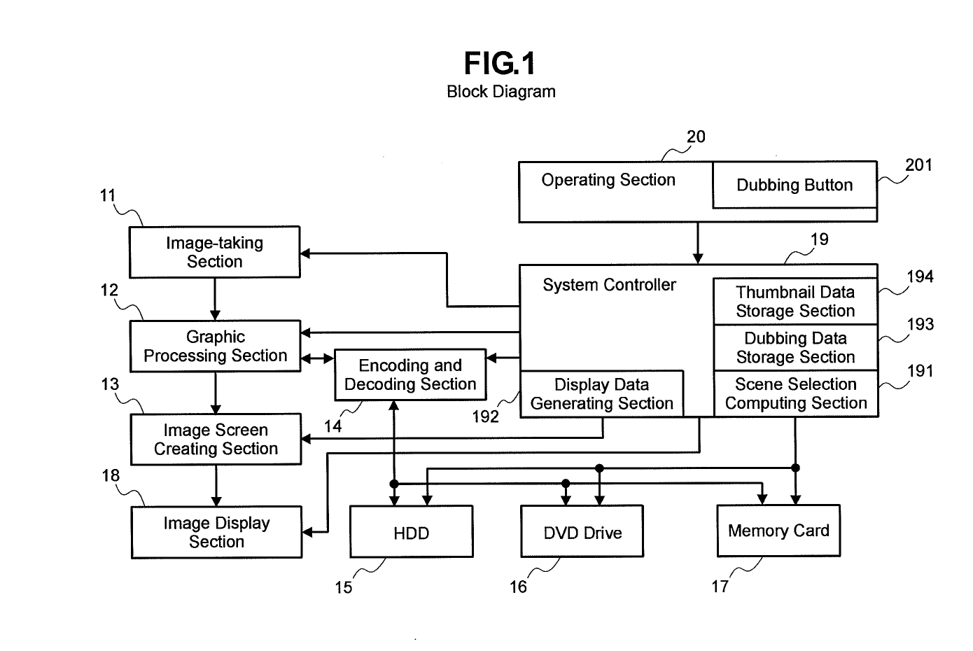

Embodiment 1 is explained in reference to FIGS. 1-13 and 15-17.

### Outline of Configuration

FIG. 1 is an example block diagram showing an example system configuration of an example video camera.

At the image-taking section 11 where taking of pictures is performed, a zooming and iris positioning of the lens (not shown) is controlled by the system controller 19. The images taken are to be converted into an electronic signal by means of CCD (charge coupled device) sensors and CMOS (complementary metal oxide semiconductor) sensors, and then, after noise elimination and signal amplification processing, are to be converted again into a digital signal.

The digital signal outputted from the image-taking section 11 is treated for noise elimination and other processing at the graphic processing section 12 to become a digital image signal. The digital image signal outputted from the graphic processing section 12 may be overlapped with textual information by the image screen creating section 13, and is sent to the image display section 18 where the image presently being captured is displayed by means of an LCD (liquid crystal display) and/or EVF (electric view finder) arrangement. The image display section 18 may alternatively be composed of an ELD (=electro luminescence display) and any other display device, other than LCD. The LCD and the EVF used in the image display section 18 may be distinguished respectively from each other in the names of a side viewer and a finder.

The digital image signal outputted from the graphic processing section 12 is also to be sent to the encoding and decoding processing section 14 where a moving image, for example, will be compressed and encoded by the MPEG2 (Moving Picture Experts Group 2) method, and, depending on the selected mode, recorded in the HDD 15 as the first recording section, or the DVD drive 16 as the second recording section.

The still image signal is compressed, for example, by the JPEG (Joint Photographic Experts Group) method, and recorded in the memory card 17. As for the moving image, there are provided two recording sections as mentioned above, i.e., the HDD 15 and the DVD drive 16. For the present embodiment, the HDD 15 is 1.8 inches in diameter having a recording capacity of 30 GB (or 1 inch of 8 GB), while the DVD drive 16 is able to drive an 8 cm DVD. This 8 cm DVD has a recording capacity of about 1.4 GB for a single layer.

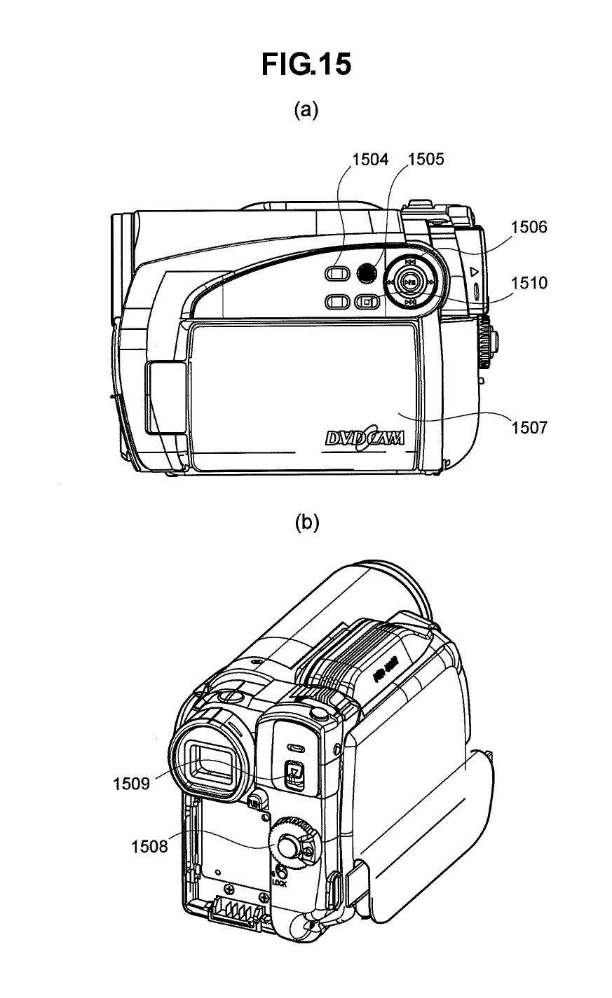

Also, this video camera in its entirety, is controlled by the system controller 19, and the operations as well as inputting procedure by the user are performed using the operating section 20. The layout of the operating section 20 is explained in reference to FIG. 15.

FIG. 15 shows an external view of an example video camera. FIG. 15(a) is a side elevational view, while FIG. 15(b) is a rear perspective view.

On the back side (the photographer's side) of this video camera, there is set the power/mode change-over switch 1508 for switch-over of power on/off and mode change. Also set is the eject switch 1509 to insert and eject a DVD disk. On the left side of the camera, there is the LCD section (the side display section) 1507 containing the LCD, which section is also called as the image display section 18. The LCD section facilitates opening and closing of the LCD and turning the LCD display face so as to make it face to the outer side (the direction of the display face is turned inside out or toward the surface of the paper in FIG. 15(a)). Further, there are arranged the dubbing button 1505 which permits dubbing processing from the HDD 15 to the DVD inserted in the DVD drive 16 by one touch on the button (201 in FIG. 1), the disk navigation button 1504 to activate the navigation display, the cursor button 1506, and the stop button 1510 to finalize and terminate processing.

When the LCD section is opened with its LCD display face turned toward the outer side, the dubbing button 1505, the disk navigation button 1504, and the cursor button 1506 are all on the same side as the display providing easy-to-use convenience for dubbing operation.

### (2) Outline of Operation

The outline of an example operation of dubbing from the HDD 15 to the DVD inserted in the DVD drive 16 is going to be explained in reference to FIG. 1 and FIG. 15.

By operation from the operating section 20, the power source is put on and the HDD mode is selected. On pushing the disk navigation button (1504 in FIG. 15), the display data generating section 192 reads out the thumbnail image data of each scene recorded in the HDD 15 and stores the data in the thumbnail data storage section 194. The display data generating section 192 also reads out the data recorded in the HDD for which dubbing has been done and stores it in the dubbing data storage section 193. The system controller 19 generates a display data of thumbnail list by adding a dubbing data on the basis of the thumbnail data and the dubbing-completed data read out as above, and sends the above display data of the thumbnail list to the image screen creating section 13. Based on the display data of the thumbnail list, the image screen creating section 13 generates the thumbnail list display screen (navigation screen) and show it for viewing on the LCD of the image display section 18.

If the user pushes the dubbing button 201 of the operating section 20 in the above conditions, the system controller 19 detects the dubbing button 201 has been pushed, and proceeds to dubbing processing.

The display data generating section 192 generates the dubbing menu screen data and sends it to the image screen creating section 13. The image screen creating section 13 generates the dubbing menu screen (navigation screen) and shows it on the LCD of the image display section 18. At this point, the user is to determine a dubbing mode from the dubbing menu for choosing whether: all the scenes recorded in the HDD are to be dubbed (All-Scene Dubbing), all of only the undubbed scenes are to be dubbed (All-Undubbed-Scene Dubbing), or selected scenes are to be dubbed (Selected-Scene Dubbing).

For example, when the mode of “All-Undubbed-Scene Dubbing” is selected, the system controller 19 acquires the information about the HDD 15 and the DVD inserted in the DVD drive 16, and checks their performance to find out possibility of dubbing. The system controller 19 reads out the number and the data volumes of undubbed scenes recorded in the HDD 15 from the dubbing data storage section 193, and makes the scene selection computing section 191 calculate to select the scenes that can be dubbed to the DVD loaded in the DVD drive 16, using the above data on the undubbed scenes together with the recordable capacity of the loaded DVD. As the object scenes for dubbing, the scene selection computing section 191 selects only the undubbed scenes recorded in the HDD 15 in number order until the data volumes fill up the remaining capacity of the DVD.

If the loaded DVD cannot take in any additional selected scenes because of limited capacity, the overflowing selected scenes are color-coded or differently shaded on the display, to indicate which undubbed scene or scenes can be dubbed to what number (2nd, 3rd, etc.) of DVD. Since the information about the first DVD has been acquired, the same recordable capacity of DVD can be used for computation regarding subsequent needed DVDs. It may happen that a second, third, or any other additional DVD used has a decreased capacity because of some other data recorded in advance, but it is enough to estimate the capacity on the basis of 1.4 GB, such being the capacity of a standard 8-cm DVD. Thus, the user may confirm the scene selected to execute a proposed dubbing operation.

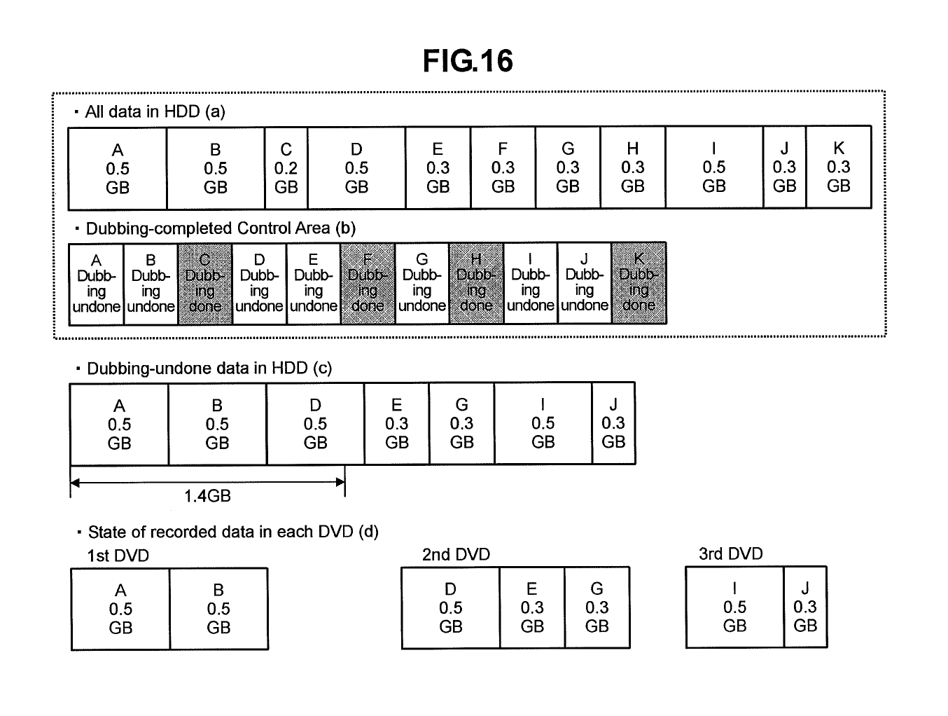

FIG. 16 shows an example of data selection for object scenes according to the present embodiment. In reference to FIG. 1 and FIG. 16, explanation is made concerning an example of the data selection for object scenes performed by the scene selection computing section 191. It is assumed that the available capacity of a DVD to be used is 1.4 GB. Explanation here is based on the assumption that the data volume of the scene A recorded in the HDD 15 is 0.5 GB, the data volume of the scene B is 0.5 GB, the scene C is 0.2 GB, the scene D is 0.5 GB, the scenes E, F, G and H are 0.3 GB each, the scene I is 0.5 GB, and the scenes J and K are 0.3 GB each. Further, it is premised that the undubbed data is kept stored on the HDD, and the dubbing-completed data is kept stored in the dubbing control data area.

When the disk navigation button 1504 is pushed, the system controller 19 in FIG. 1 reads in the thumbnail data of each scene and the dubbing-completed data (FIG. 16(b)), both from the HDD in which these data are recorded, and composes the navigation screen. Then, the image screen creating section 13 creates the navigation screen, which is to be shown on the LCD of the image display section 18. In the HDD, the data from A to K are recorded as in FIG. 16(a), meaning that A to K are to be shown in thumbnails. The dubbing-completed scenes C, F, H, and K are marked as dubbing-done or -completed (see shaded areas in FIG. 16). At this stage, on pushing the dubbing button 1505 and choosing “All-Undubbed-Scene Dubbing,” from the dubbing menu, the system controller 19 in FIG. 1, based on the dubbing data from the dubbing data storage section 193, distinguishes the dubbing-completed scenes and the undubbed scenes from each other for selection of only the latter. Thus, only the undubbed scenes are shown on the navigation screen. Namely, only the undubbed scenes A, B, D, E, G, I, and J as illustrated in FIG. 16(b), are to be shown as illustrated by FIG. 16(c).

The data of those scenes which are to be dubbed in the loaded first DVD are to be selected starting from the headmost scene A and continuing with other consecutive scenes within the range not exceeding the balance of capacity of the DVD. That is, the data amount of 0.5 GB is first taken from the first scene A, and check is made if there still is any balance (i.e., available recordable space) to fill up the capacity of DVD or 1.4 GB. If the data amount of the scene A exceeds 1.4 GB, an error message like “Dubbing not possible due to short capacity” will be displayed. If the data amount is below 1.4 GB, another 0.5 GB is taken from the next scene B and added to the above amount of the scene A. Here again, check is made if there still is any balance to fill up the capacity of DVD or 1.4 GB.

Since the total data amount of the scenes A and B is 1.0 GB which leaves some balance to reach 1.4 GB. Then, the data volume of 0.5 GB is taken from the next scene D and added to the above data amount of the scenes A and B. The data volume of the scenes A, B, and D now totaling to 1.5 GB is found, by comparison, exceeding the capacity of the DVD or 1.4 GB. This result determines that the first DVD can accommodate dubbing of the scenes A and B (the first DVD shown in FIG. 16(d)).

In the same way as above, computation is made starting from the scene D to see which scenes the second DVD can take in for dubbing. It becomes possible for the second DVD to take dubbing of the three scenes D, E, and G (the 2nd DVD in FIG. 16(d)). Likewise, the third DVD is available for dubbing of the scenes I and J (the 3rd DVD in FIG. 16(d)). Such processing is to be continued up to the last undubbed scene.

Once the scenes are selected for each dubbing object by the scene selection computing section 191, the display data generating section 192 reads out the thumbnail display data in the HDD 15 corresponding to the dubbing object scenes and creates the dubbing confirming screen data in which the display to confirm execution of dubbing operation is combined with the thumbnail displays. The dubbing confirming screen data is sent to the image screen creating section 13, where the dubbing confirming screen is generated on the basis of the dubbing confirming screen data and displayed in the image display section 18.

The user carries out dubbing after ascertaining which scenes are going to be dubbed in which DVD. The data of the selected scenes are read out from the HDD 15 and thus the operation of dubbing the scenes to the DVD loaded in the DVD drive 16 is started.

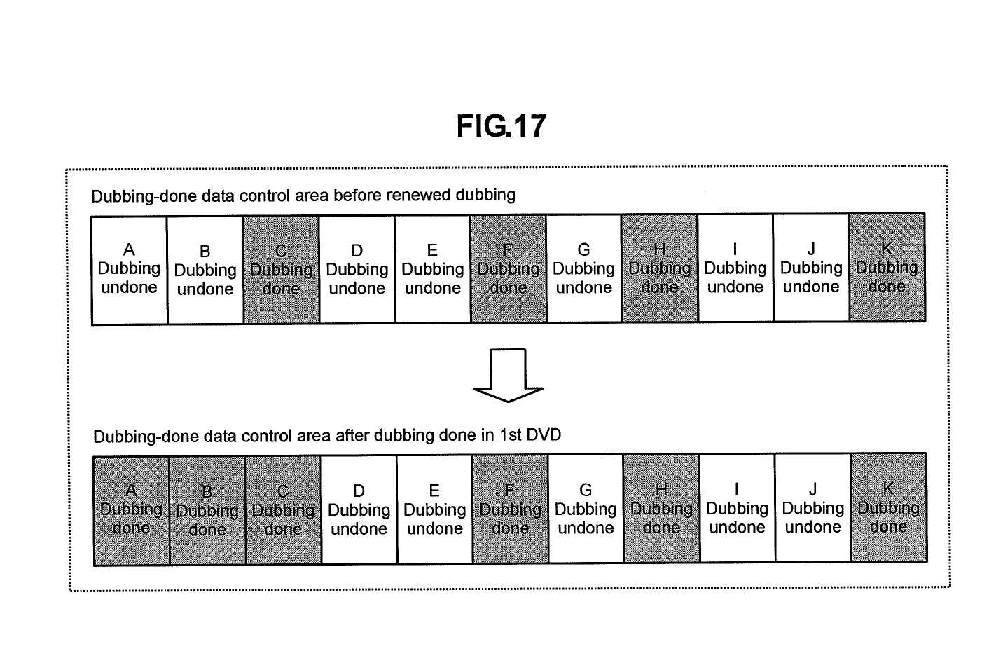

When the dubbing to the first DVD is completed, the dubbing-completed data of the scenes A and B are to be stored in the dubbing-completed data control area on the HDD, as illustrated in FIG. 17 (note that A and B are now shaded in the lower drawing). If the first DVD can take dubbing of all the selected scenes, dubbing processing is terminated. At this point, if deletion is executed on the dubbed scene deletion confirming screen, the data of the dubbed scenes and the dubbing-completed data are to be eliminated from the HDD 15, with the dubbing processing brought to termination.

In case after dubbing has been completed of the dubbing object scenes selected for the first DVD, and there are remaining some other scenes for which dubbing is undone, the display data generating section 192 generates the continued dubbing confirming screen data requesting exchange of a loaded DVD so as to continue dubbing to the second DVD. Display of the continued dubbing confirming screen in the image display section 18 is performed via the image screen creating section 13.

If the user thus exchanges the DVD, the same procedures as with the first DVD are to be repeated. The system controller 19 checks to see if the video camera is ready for dubbing operation; the scene selection computing section 191 again selects the scenes recordable in the exchanged DVD; the display data generating section 192 creates the dubbing confirming screen data; and the dubbing confirming screen is displayed in the image display section 18 via the image screen creating section 13. The user confirms the selected scene and executes a dubbing operation. Hereafter, the above processing is repeated to continue dubbing of the data of each scene to the DVD, until none of the selected scenes is left undubbed.

As explained above, the present embodiment is intended to automatically display thumbnail images of the scenes to be recorded in the DVD, when dubbing is made from the HDD 15 to the DVD. Further, in a case where one DVD is not enough to contain all the scenes, those scenes to be recorded in a second DVD, a third DVD, and more . . . are also displayed automatically before a start of dubbing. Therefore, the user can easily recognize which scene is going to be recorded in which DVD. Also, the dubbing button 1505 provided on the main body of the video camera is very handy, as it permits dubbing operation any time without a need for carrying a remote-control unit around.

### (3) Operation in Detail

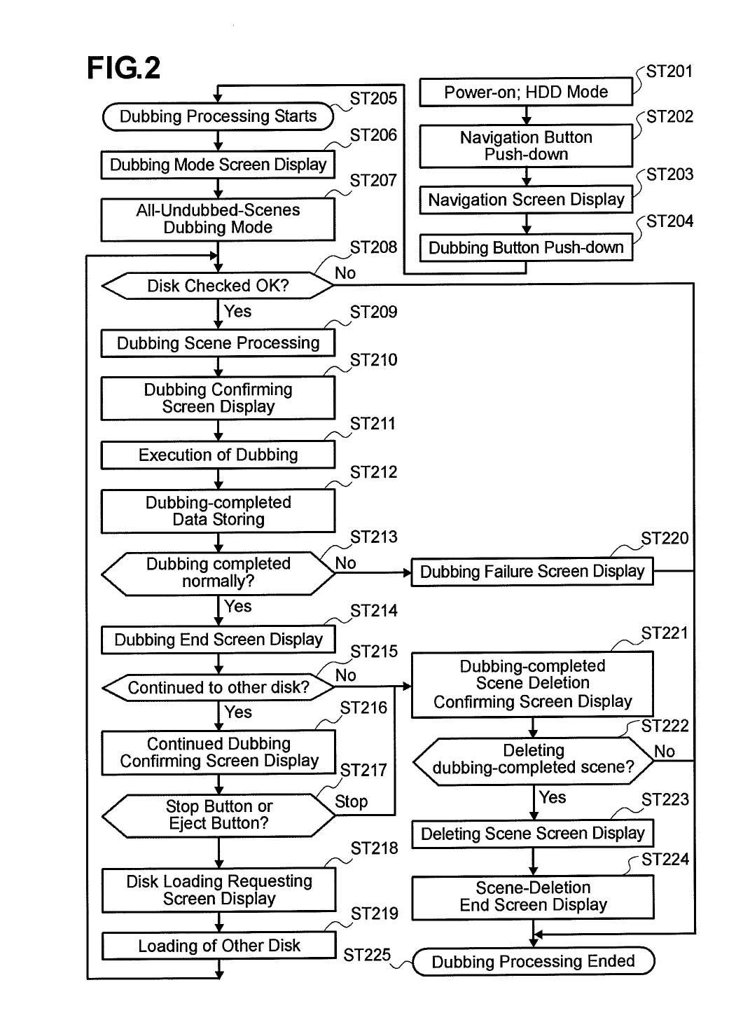

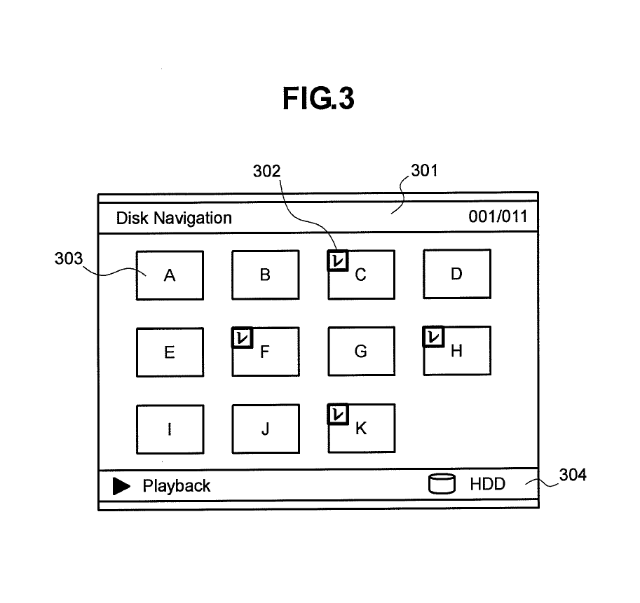

The flow of the above-mentioned dubbing processing performed by the video camera is now explained in detail with reference to the flow chart in FIG. 2 and the illustration of screens in FIGS. 3-13. It is assumed here that 11 scenes are recorded in the HDD 15.

FIG. 2 is an example flow chart showing an example flow of processing in the case of “all-undubbed-scenes dubbing.” Unless otherwise expressly specified, the processing in the flow chart is to be executed by the system controller 19 (including the scene selection computing section 191, the display data generating section 192, the dubbing data storage section 193, and the thumbnail data storage section 194).

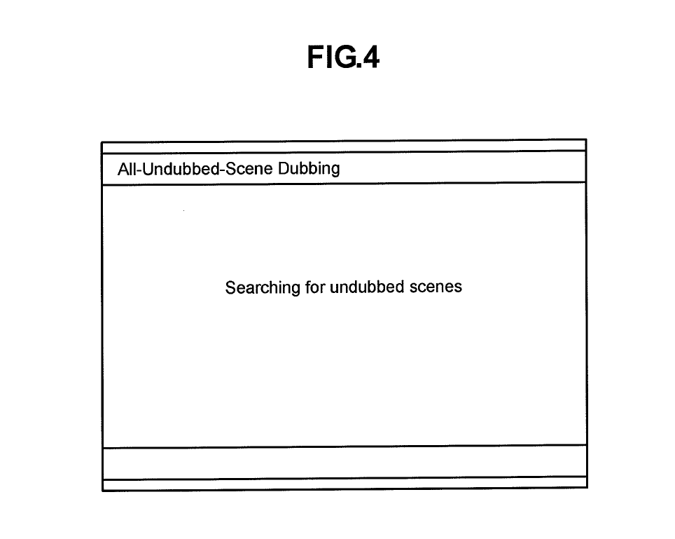

FIG. 3 shows an example of a navigation screen display for the HDD mode; FIG. 4 shows an example of a screen display in which search is in progress for the undubbed scenes;

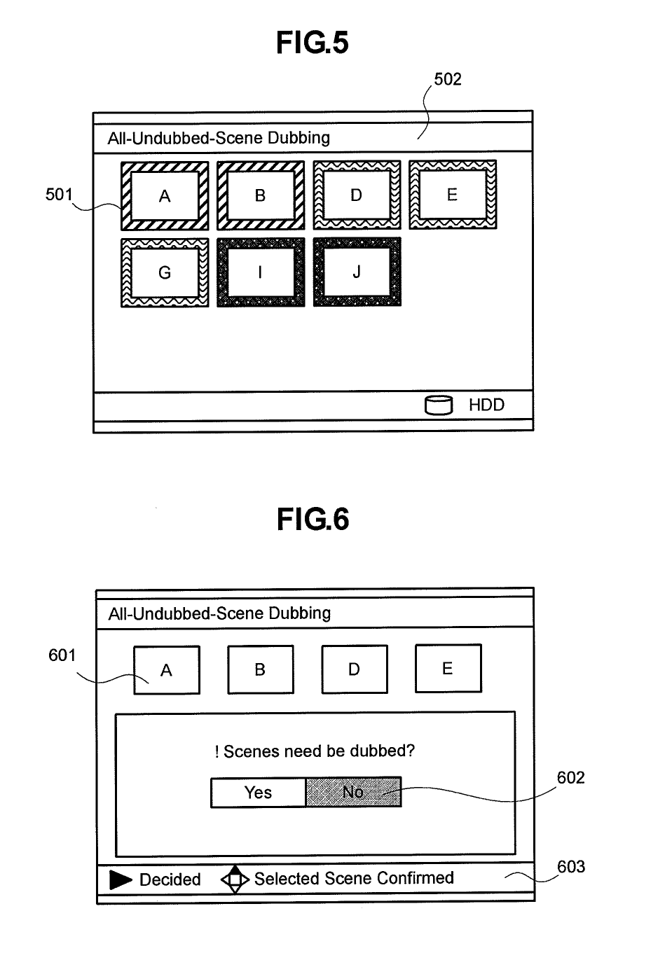

FIG. 5 is an example of a screen display of only the undubbed scenes;

FIG. 6 is an example of a dubbing start confirming screen display;

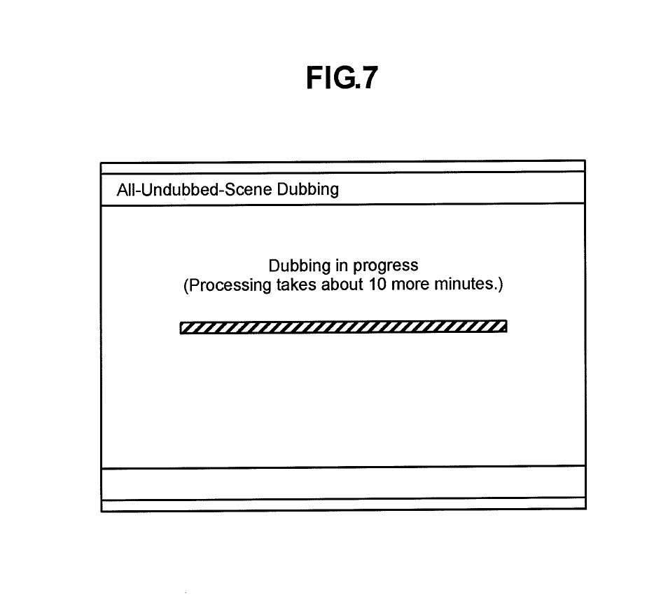

FIG. 7 is an example of a dubbing-in-operation screen display;

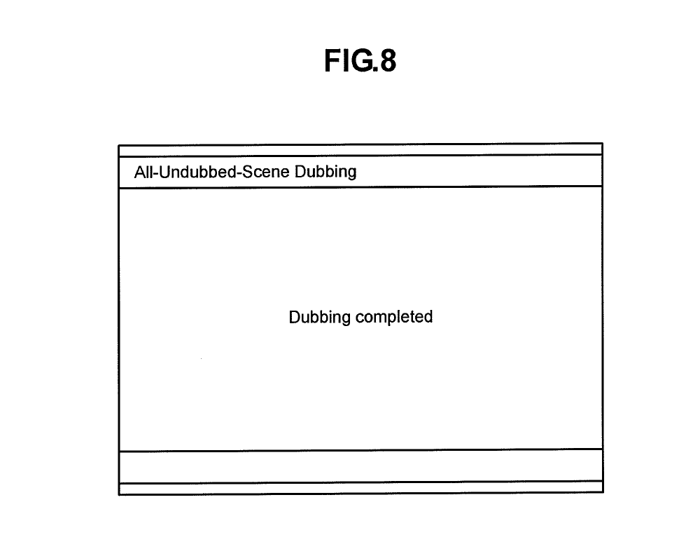

FIG. 8 is an example of a dubbing-completed screen display;

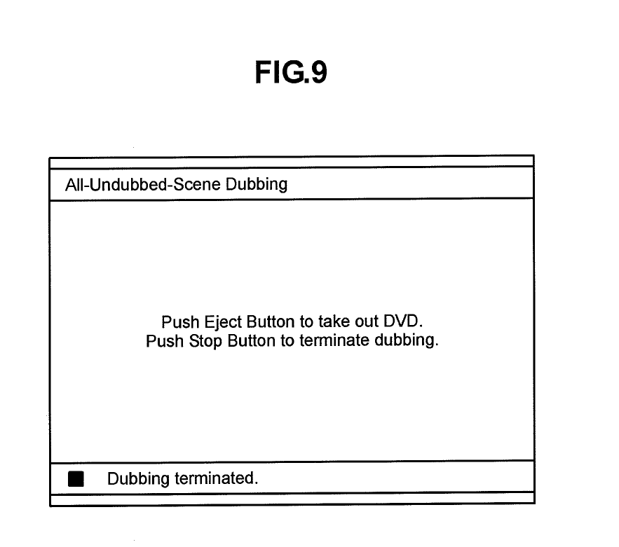

FIG. 9 is an example of a dubbing-processing completion confirming screen display;

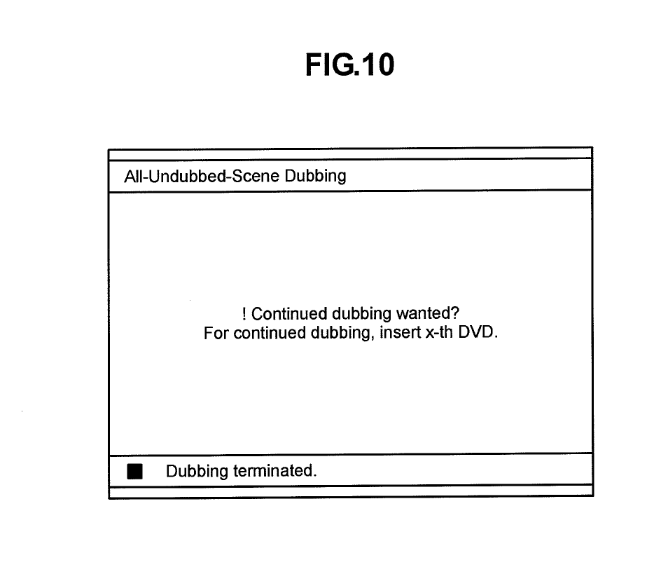

FIG. 10 is an example of a continued dubbing confirming screen display;

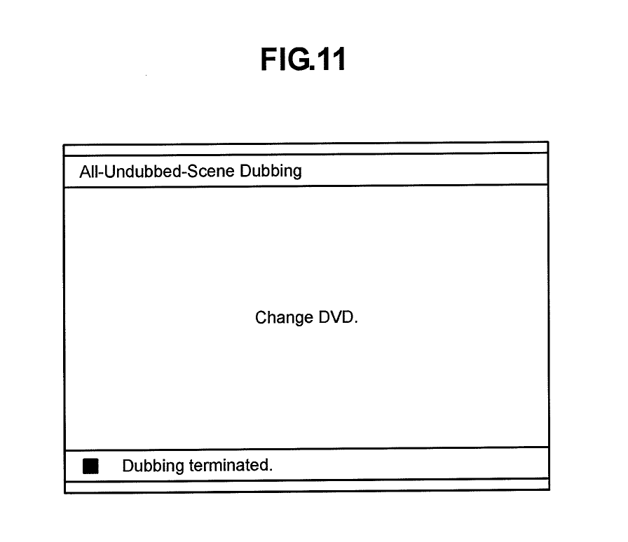

FIG. 11 is an example of a disk exchange requesting screen display;

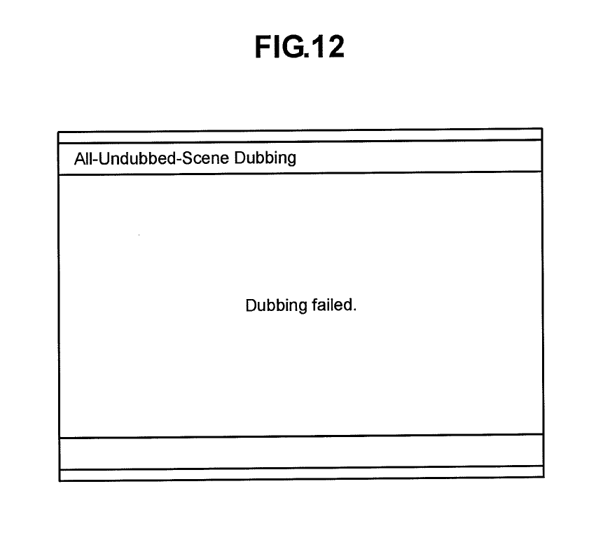

FIG. 12 is an example of a dubbing failure screen display;

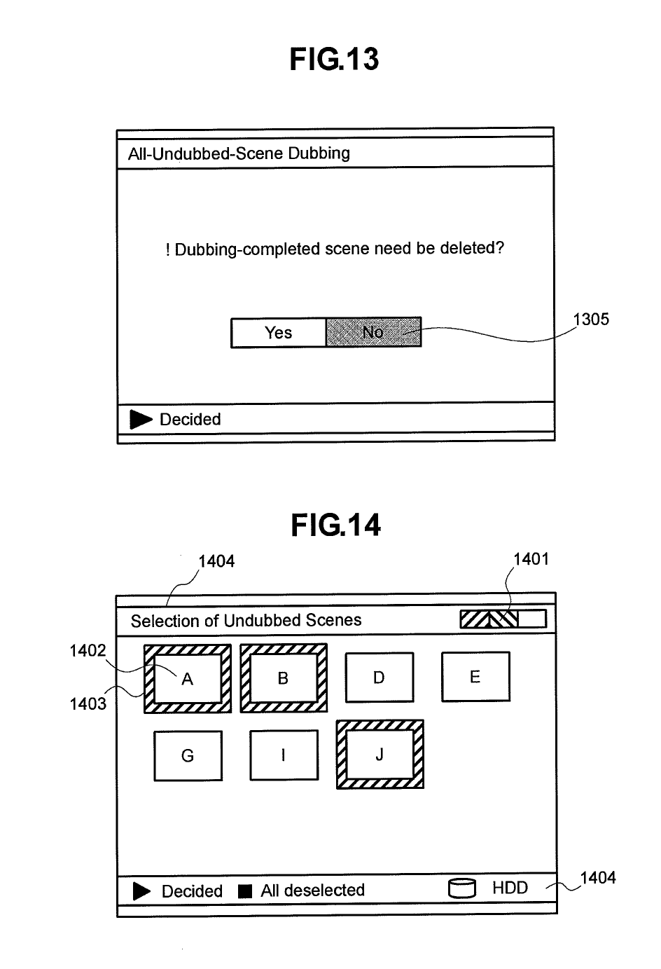

FIG. 13 is an example of a dubbing-completed scene deletion confirming screen display; and

FIG. 14 is an example of an undubbed-scene dubbing selection screen display.

With reference to FIG. 2, explanation is made of an example operation for dubbing of all undubbed scenes. At Step 201 (in the drawing, STEP is expressed in an abridged form of “ST”), the power/mode change-over switch (1508 in FIG. 15) of the operating section 20 is operated to choose the HDD mode in which the HDD 15 is used as a recording media; at Step 202, pushing-down on the disk navigation button (1504 in FIG. 15) of the operating section 20 will induce the list of scenes recorded in the HDD 15 to be displayed in the thumbnail form (navigation screen) as shown in FIG. 3, at Step 203.

In the center of the navigation screen in FIG. 3, the thumbnail pictures (A-K) 303 typical of the scenes are displayed. Already in the screen, the thumbnails of those scenes for which dubbing has been completed are identified with the mark 302. In the upper part of the screen, there is the title bar 301 indicating the title of the screen “Disk Navigation,” “011” of the total number of scenes, and “001” or the serial number of the presently selected thumbnail picture A 303. The lower part of the screen carries the operational guide 304 indicating the playback button mark to see the scene represented by the currently selected thumbnail, and the mark “HDD” showing the dubbing source for the scene selected in the current screen.

When pushing-down on the dubbing button 201 is detected at Step 204, dubbing processing is started at Step 205. At Step 206, the screen of the dubbing mode is displayed. By the way, if the navigation button is not pressed at Step 202, but if the dubbing button 201 is pressed, for example, while waiting for shooting (while the image taken is passing through the camera to be displayed in the LCD section), the screen of Step 206 is displayed. Also, even if the dubbing button 201 is not pressed, but if from Step 203 and through menu selective operation, the “dubbing mode screen display” is executed, Step 206 is executed.

If the user selects the all-undubbed-scenes dubbing mode at Step 207, the system controller 19 selects only the undubbed scenes and carries out processing for display. In case processing is taking time at this stage, a screen designed like FIG. 4 may be displayed announcing that the undubbed scenes are being searched for.

At Step 208, it is necessary to check in advance if the data of the DVD loaded in the DVD drive 16 can be obtained and recorded; if the scenes are recorded in the HDD 15; and if the video camera is in a condition of being able to do dubbing judging from the data on the operational state of the camera. If the check result is no good, dubbing processing is terminated at Step 225. If the check result is OK, processing is made at Step 209 as to which undubbed scene is to be dubbed to the n-th DVD, with the result to be displayed in the navigation screen. The example of display in FIG. 5 shows (via different colors, shading or patterns) that the scenes A and B are dubbed to the first DVD, the scenes D, E and G are to the second DVD, and the scenes I and J are to the third; each dubbing destination being indicated with color-coded frames (the colored frames 501 in FIG. 5).

Though it is automatically selected to which number of DVD which undubbed scene is to be dubbed, it is also possible for the user to change the selection. In the above-explained case, the second DVD takes the scenes D, E and G, and the third DVD takes the scenes I and J. But, for example, the user might want the scene G to be dubbed together with the scenes I and J instead of D and E. In such a case, by manipulating the cursor button (1506 in FIG. 15) in the operating section 20, instruction may be issued to change the DVD to which the scene G is dubbed, from the second DVD to the third one. The scene selection computing section 191, as explained in the earlier part, sums up the data volumes of the scenes G, I and J dubbed to the third DVD and compares the sum with an available capacity of the DVD to find out whether dubbing is possible or not. In the present example, the sum of the data volumes of the scenes G, I and J is 1.1 GB, and it is found that this total data volume can be taken for dubbing by the third DVD which has an available capacity of 1.4 GB or below. And, this change of selection is reflected on the navigation screen, which now indicates: the scenes A and B are dubbed to the first DVD, the scenes D and E to the second DVD, and the scenes G, I and J to the third DVD; each DVD being identified by color-coding. In the above manner, it becomes possible for the user to plan and confirm, before exercising a dubbing operation, which undubbed scene is to be dubbed to what number of DVD, to much better usability for the user. The title bar 502 indicates the screen title of “All-Undubbed-Scene Dubbing.” At Step 210, the user is to confirm the scene for dubbing.

The dubbing confirming screen as shown in FIG. 6 displays, in the center area, the thumbnail pictures (A, B, D and E) 601 corresponding to the scenes A, B, D and E selected as the dubbing objects, and the dubbing confirming dialog (yes/no dialog) 602 to confirm execution of dubbing operation. The operational guide 603 in the lower part of the screen has the decision button mark to decide whether the dubbing operation should be continued or not and also the button mark on the cursor to confirm the selected scene. Looking at this dubbing confirming screen, the user is able to consider if the selected scene matches the user's intention and decide to continue or stop dubbing operation.

The dialog sign for confirming whether dubbing should be executed or not is also provided along with the thumbnail pictures, a user-friendly arrangement that enables the user to immediately stop dubbing in case the thumbnail picture shown is not as intended. When to continue a dubbing operation is desired, choose “Yes” in the dubbing confirming dialog 602 by maneuvering the cursor button (1506 in FIG. 15) of the operating section 20 and press down the decision button. When to stop a dubbing operation is desired, choose “No” in the dubbing confirming dialog 602 and press down the decision button. The dubbing operation is thus terminated with the display returning to the navigation screen.

When dubbing is continued, the dubbing-in-processing screen as shown in FIG. 7 is displayed at Step 211, indicating that the dubbing is under way, while starting the dubbing operation simultaneously. The same screen also displays approximate time required for completion of the dubbing operation computed from the data volume of the scene to be dubbed, transfer speed, and writing speed.

After dubbing has been completed, the data concerning the dubbed scene having completed dubbing is written in the HDD at Step 212. Then, at Step 213, it is judged if the dubbing processing has finished normally, and at Step 214,the dubbing end screen is displayed. (For example, a screen as shown in FIG. 8 is displayed.) In case the dubbing processing is not normally completed, the dubbing failure screen is displayed at Step 220, and the dubbing processing is terminated at Step 225. (For example, a screen as shown in FIG. 12 is displayed)

When the dubbing is completed normally, consideration is given as to whether the dubbing is to be continued at Step 215. If the first DVD cannot contain all of the undubbed scenes, the continued dubbing confirming screen (FIG. 10) is displayed at Step 216. If the user presses the “eject” button (1509 in FIG. 15) at Step 217, the disk loading requesting screen (FIG. 11) is displayed at Step 218, and the second DVD is inserted at Step 219, and operations are looped back to Step 208. In this way, similar operations beginning from Step 208 are to be repeated until the undubbed scenes have all been processed for dubbing. In case dubbing cannot be processed due to any abnormality found with the disk at Step 208, the dubbing processing is terminated at Step 225.

When dubbing is considered to have been completed for all of the undubbed scenes at Step 215, a screen is displayed to confirm the request for deletion of dubbing-completed scenes at Step 221. In relation to this dubbing-completed scene deletion confirming screen (FIG. 13), if the user (at Step 222) does not want to delete the data of the dubbing-completed scenes from the HDD 15, the user should manipulate the cursor button 1506 in FIG. 15 so as to select and decide/select the “No” mark in the scene deletion confirming dialog (1305 in FIG. 13), thus allowing, at Step 225, the dubbing processing to be terminated and the display to return to the originating navigation screen.

If the user is to select and decide “Yes” mark in the scene deletion confirming dialog (Step 222), the deleting scene screen indicating erasing in process of the data of the dubbing-completed scenes is displayed at Step 223. At Step 224, the scene-deletion end screen is displayed indicating the deletion of the scenes has been finished, and at Step 225,the dubbing processing is terminated with the display returning to the originating navigation screen.

If it is selected and decided before start of dubbing processing (for example, before Step 211) to automatically delete the scenes recorded in the HDD 15 immediately after the dubbing has been successfully completed, the user, after having given the instruction once, can just leave dubbing and deletion to be self-operated and completed, which the user may find convenient.

When the dubbing processing is completed, a screen as shown in FIG. 9 is displayed to notify the user that the dubbing processing has ended. If it is necessary to suspend dubbing at Step 217, the stop button (1510 in FIG. 15) should be pressed down. Thereafter, the same deletion procedure as abovementioned should be taken from Step 221.

In the foregoing, explanation has been made of the dubbing processing of all the undubbed scenes. “All-Undubbed-Scene Dubbing” has been explained as the dubbing of the data of all the undubbed scenes recorded in the HDD, but the similar treatment shall apply also to the processing in the case that the scenes included in the one DVD loaded in the video camera are selected.

### EXAMPLE EMBODIMENT 2

The embodiment 2 (the dubbing processing of a specific scene) is explained in reference to FIG. 2 and FIG. 14. The processing in the case that all undubbed scenes are selected has already been explained. It is also possible to have he user select the scenes for dubbing out of the undubbed scenes. In this case, the “selected scene dubbing mode” expressed in the dubbing mode selection screen at Step 206, is selected at Step 207. And if the “selection of undubbed scenes” is executed via operation in the navigation screen of Step 203, the dubbing processing of the selected undubbed scenes is to be carried out. An example of a screen in which the user can choose specific scenes, is shown in FIG. 14.

As shown in FIG. 14, the thumbnail pictures (A, B, D, E, G, I and J) 1402 of the undubbed scenes and the color frames 1403 to identify the dubbing objects selected by the user are arranged in the center part of the screen. The title bar 1404 carries “Selection of Undubbed Scenes,” the title of the screen.

The capacity bar 1401 indicates the capacity of the DVD in a visual manner. The diagonally shaded square on the left of the bar indicates a rough total volume of the scenes already selected and marked by the colored frame 1403. The right square (white space) of the bar indicates the rough blank capacity of DVD available for new recording aside from those data that have been already recorded or selected. With display of such a bar, the user can select scenes for dubbing taking the available remaining capacity into consideration. The total capacity already used for the selected scenes may well be indicated in a numeric value instead of a pictorial figure.

In the lower part of the screen, there is provided the operational guide 1404 containing the guide sign for the decision button to decide dubbing of selected scenes and the other guide sign for the all selection canceling button to totally cancel selected scenes.

### EXAMPLE EMBODIMENT 3

The embodiment 3 (application of differential indication of dubbing-completed scenes against undubbed scenes) is now explained hereunder. The differential indication of dubbing-completed scenes against undubbed scenes explained in relation to the embodiments 1 and 2 is also applicable in still other aspects of this example video camera. Here is the explanation. In regard to this video camera, each scene is recorded as to whether it is in the dubbing-completed state or in the undubbed state by means of the dubbing-completed control area as shown in FIG. 16(b). Such data as whether the state is dubbing-completed or undubbed is particularly effective not only in the dubbing aspects in the above embodiments 1 and 2, but also likewise effective in the following aspects.

For example, it is effective in the aspect of deleting scenes. Firstly, in this case, a list of thumbnail pictures representative of the scenes recorded in the HDD 15 as shown in FIG. 3 is displayed (the navigation screen). In the center part of the screen, as explained above, the thumbnail pictures (A-K) 303 representative of the corresponding scenes are displayed, and those scenes for which dubbing has been completed are shown with the “dubbing-completed” mark 302. If, in this state, the “deletion of scene” is chosen through selective maneuvering of the menu, the processing moves to the “deleting scenes” mode.

In the navigation screen, the dubbing-completed mark 302 is shown, and there are occasions when it is desired to select and delete some scenes out of the dubbing-completed or undubbed scenes. Thus, arrangement is so made for the user as to be able to give instruction to display only the dubbing-completed scenes or only the undubbed scenes through selective maneuvering of the menu. When such instruction is given, the system controller 19, based on the dubbing data from the dubbing data storage section 193 and by the function of the scene selection computing section 191, distinguishes the dubbing-completed scenes and the undubbed scenes from each other and selects either the dubbing-completed scenes only or the undubbed scenes only. Thus, either the dubbing-completed scenes only or the undubbed scenes only is displayed in the navigation screen.

Assume that, for example, the user might want to delete some of the scenes in order to increase the remaining available capacity of the HDD, but that the user might be also afraid of deleting undubbed scenes by irredeemable mistake. If the above procedure is followed, it becomes possible for the user to display only the dubbing-completed group of scenes and avoid such an irredeemable mistake as mentioned above, thanks to the user-friendly feature of the device.

The above feature is also effective when, for example, any scene is locked (for protection from deleting it by an error). As in the above case of deleting any scene, if the “lock” is selected in the navigation screen, the screen will soon display both the dubbing-completed scenes and the undubbed scenes mixed together. But the user has a choice of displaying only the dubbing-completed scenes or only the undubbed scenes on the screen by properly issuing instruction through selective maneuvering of the menu. In this way, for example, the user can display only the undubbed scenes which are irredeemable if deleted by mistake and can select the scenes to be locked out of those displayed, availing of the best usability of the device. Or otherwise, the above deletion of scenes can be combined with the locking. Firstly, at the locking step, only the dubbing-completed scenes are displayed, and any desired scene out of those displayed is to be locked; then, at the scene deleting step, only the dubbing-completed scenes are displayed and all-deleted. In this way, it is possible to delete all of unnecessary, dubbing-completed scenes only effectively and conveniently.

In additional aspects other than mentioned above, it is made possible to display both the dubbing-completed scenes and the undubbed scenes mixed together; or otherwise, to display the dubbing-completed scenes alone or the undubbed scenes alone. Narrowed range of display brings about much enhanced convenience of use, and makes it easier for the user to select desired scenes.

In the foregoing, explanations have been provided about the example embodiments 1-3.

In the above embodiments, at Step 210 where the user is to confirm the scene for dubbing, the thumbnail pictures for the dubbing objects and the dubbing confirming display are arranged to appear in the same screen, but it may as well do to display these two objects separately in different screens. For example, the thumbnail pictures are to be displayed for a certain length of time, and after that, display is to be switched over to the dubbing confirming screen.

In regard to the handling of buttons during dubbing in progress, it is preferable that the video recording button, stop button, power cut-off button, etc., should be safeguarded from inadvertent external contact.

At least a portion (if not all) of the present invention may be practiced as a software invention, implemented in the form of one or more machine-readable medium having stored thereon at least one sequence of instructions that, when executed, causes a machine to effect operations with respect to the invention. With respect to the term “machine”, such term should be construed broadly as encompassing all types of machines, e.g., a non-exhaustive listing including: computing machines, non-computing machines, communication machines, cameras, set-top boxes, cell phones, etc. With regard to the term “one or more machine-readable medium”, the sequence of instructions may be embodied on and provided from a single medium, or alternatively, differing ones or portions of the instructions may be embodied on and provided from differing and/or distributed mediums. A “machine-readable medium” includes any mechanism that provides (i.e., stores and/or transmits) information in a form readable by a machine (e.g., a processor, computer, electronic device). Such “machine-readable medium” term should be broadly interpreted as encompassing a broad spectrum of mediums, e.g., a non-exhaustive listing including: electronic medium (read-only memories (ROM), random access memories (RAM), flash cards); magnetic medium (floppy disks, hard disks, magnetic tape, etc.); optical medium (CD-ROMs, DVD-ROMs, etc); electrical, optical, acoustical or other form of propagated signals (e.g., carrier waves, infrared signals, digital signals); etc., as existing on a tangible carrier.

Method embodiments may be emulated as apparatus embodiments (e.g., as a physical apparatus constructed in a manner effecting the method); apparatus embodiments may be emulated as method embodiments. Still further, embodiments within a scope of the present invention include simplistic level embodiments through system levels embodiments.

In beginning to conclude, reference in the specification to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment or component, it is submitted that it is within the purview of one skilled in the art to effect such feature, structure, or characteristic in connection with other ones of the embodiments and/or components. Furthermore, for ease of understanding, certain method procedures may have been delineated as separate procedures; however, these separately delineated procedures should not be construed as necessarily order dependent in their performance, i.e., some procedures may be able to be performed in an alternative ordering, simultaneously, etc. Further, unless indicated otherwise, any of the specific procedures may be effected in real-time during operation of any apparatus and/or method.

This concludes the description of the example embodiments. It is needless to say that the present invention is not limited to the above-mentioned embodiments and it should be also understood that the present invention may be variously embodied without departing from the spirit of the invention. For example, the above embodiments are minutely explained in order to have the present invention understood easily, but this does not necessarily intend to limit this invention to what includes all details and compositions explained. As a matter of fact, it is possible that a part of composition of any embodiment herein may be replaced with any part of composition of any other embodiments; or otherwise, it is also possible that the composition of any embodiment herein may be combined with the composition of any other embodiments.

What is claimed is:

1. A recording and reproducing device comprising:
a recording and reproducing module to record and reproduce image and sound data on and from a first recording media and a second recording media, both intended for recording image and sound data, and
a dubbing control module which makes a display module to show a display screen for selecting the image and sound to be dubbed from said first recording media to said second recording media, and which dubs image and sound data from said first recording media to said second recording media;
wherein said dubbing control module, responsive to a user's request, is configured to show in said display screen a list of only the image and sound data which have not been dubbed yet from among the image and sound data recorded in said first recording media.

2. The recording and reproducing device according to claim 1, wherein said dubbing control module, responsive to a user's request, automatically selects only the image and sound data which have not been dubbed yet, from out of the image and sound data recorded in said first recording media, and dubs the same to said second recording media.

3. The recording and reproducing device according to claim 1, wherein said second recording media is a recording media of a removable type, and wherein said dubbing control module is configured to indicate segmentation as to what number of said removable second recording media the image and sound data to be dubbed from said first recording media to said second recording media can be dubbed into.

4. The recording and reproducing device according to claim 3, wherein said dubbing control module conducts dubbing control of the image and sound data which has been segmentation indicated, while dubbing and exchanging said retrievable second recording media to effect such segmentation is conducted.

5. The recording and reproducing device according to claim 1, wherein said dubbing control module enables the user to select the image and sound data the user wants dubbed, from out of the image and sound data recorded in said first recording media but not dubbed yet.

6. The recording and reproducing device according to claims 2, wherein said dubbing control module deletes from said first recording media, the image and sound data which have already been dubbed in said second recording media.

7. The recording and reproducing device according to claims 4, wherein said dubbing control module deletes from said first recording media, the image and sound data which have already been dubbed in said second recording media.

8. The recording and reproducing device according to claims 5, wherein said dubbing control module deletes from said first recording media, the image and sound data which have already been dubbed in said second recording media.

9. A recording and reproducing device comprising:
a recording and reproducing module which is to reproduce, from a first recording media having a plurality of data and the control data to control the plurality of data recorded thereon, a whole or a part of the plurality of data, and to record the reproduced data in the second recording media;
a flag attaching module to attach to the control data corresponding to the data reproduced from the first recording media and recorded in the second recording media, a flag signifying that the data stored in the first recording media has been reproduced from the first recording media and recorded in the second recording media; and
a control module to carry out control so as to reproduce and show in a list on the displaying module, those data recorded in the first recording media whose corresponding control data are not attached with the flag, and further to select the data to be recorded in the second recording media out of the data thus exhibited, and record the data thus selected in the second recording media.

10. A recording and reproducing device comprising:
a recording and reproducing module configured to dub, from a first recording media having a plurality of data and control data to control the plurality of data recorded thereon, the whole or a part of the plurality of data into a second recording media;
a flag attaching module configured to attach to those control data stored in the first recording media and corresponding to the data having been dubbed out of the plurality of data in the first recording media, a flag signifying that the dubbing has been made; and
a control module which is configured to provide control in showing one of three kinds of display screens by switching over one another according to the user's direction; to show lists of data out of the plurality of data recorded in the first recording media, a first display screen being to show both the lists of data with the flag attached and without the flag together, a second display screen being to show the list of only the data with the flag attached, and a third display screen being to show the list of only the data without the flag.

11. A recording and reproducing device comprising:
a recording and reproducing module configured to dub, from a first recording media having a plurality of data stored, a whole or a part of the plurality of data into a plurality of removable second recording media;
a selecting module to select the data to be dubbed from the first recording media to the second recording media; and
a control module wherein, in case the total volume of the data selected by the selecting module exceeds a capacity of a single unit of the second recording media, volumes of respective data selected by the selecting module and the capacity of a single unit of the second recording media are used to find out what number of the removable second recording media are required to dub the data selected by the selecting module, and the control module functions to control so as to show on the displaying module, each of the data selected by the selecting module and also identifying segmentation as to which unit of the second recording media each of the data is dubbed in.

12. A video data dubbing method comprising:
acquiring information of which video data have not been dubbed yet from management information accompanied with video data;
displaying a list of only video data which have not been dubbed yet in accordance with a result of acquiring operation;
prompting a user to select video data to be dubbed from among video data displayed in displaying operation; and
dubbing video data selected by a user.

13. A video data dubbing method comprising:
prompting a user to select video data to be dubbed from among video data recorded in a recording medium;
acquiring a volume of each video data selected by a user and a unit of capacity of a removable recording medium into which video data is to be dubbed;
calculating what number of the removable recording medium video data selected by a user in prompting operation is dubbed into by using the volume of video data and the unit of capacity acquired in acquiring operation; and
displaying what number of the removable recording medium video data selected by a user in prompting operation is dubbed into, in accordance with a result of calculating operation.
